(19) United States
(12) Patent Application Publication
(10) Pub. No.: US 2012/0273288 A1
(43) Pub. Date: Nov. 1, 2012

(54) HYBRID VEHICLE

(76) Inventors: Masahiro Yamazaki, Yamagata (JP); Yoshimasa Hayashi, Kanagawa (JP)

(21) Appl. No.: 13/383,944

(22) PCT Filed: Jun. 27, 2011
(86) PCT No.: PCT/JP2011/064710

§ 371 Date: Jan. 13, 2012

(30) Foreign Application Priority Data
Dec. 14, 2010 (JP) 2010-277911

(51) Int. Cl. B60K 1/00; B60W 10/00; B60W 20/00

(52) U.S. Cl. 180/65.265; 180/65.31

(57) ABSTRACT

A hybrid vehicle is capable of running using an engine and a motor as drive sources and includes an exhaust turbine to be driven and rotated by exhaust of the engine, a generator which generates power by being driven and rotated by the exhaust turbine, and a power supply unit which supplies electric power generated by the generator to the motor.

### TECHNICAL FIELD

The present invention relates to a technology for collecting exhaust energy of an engine in a hybrid vehicle.

### BACKGROUND ART

A hybrid system by an engine and a motor can be classified into a series type which runs only on motive power of a motor using an engine exclusively for power generation, a parallel type which runs on motive powers of an engine and a motor or only on motive power of one of them, and a series parallel type (split type) as a combination of these series type and parallel type. JP2000-225871A discloses that, in a vehicle including such a hybrid system, while kinetic energy and position energy of the vehicle are converted into electrical energy and collected by driving a motor generator from a wheel side at the time of deceleration and running downhill, the engine is assisted utilizing the collected electrical energy at the time of acceleration, and vehicle runs only on motive power of the motor at the time of running at a low speed.

### SUMMARY OF INVENTION

In a hybrid vehicle as described above, a basis for the collected electrical energy is work done by an engine. That is, energy to be collected is electrical energy obtained from the net work of the engine.

A ratio of thermal energy effectively used for motive power out of thermal energy of fuel supplied to the engine is a maximum of 30 to 34%. On the other hand, energy discarded as exhaust is composed of thermal energy (J) and dynamic energy which is a product PV (Nm=J) of a pressure P (Pa) and a flow rate V (m³), and the sum of these thermal energy and dynamic energy reaches as high as 35%. Further, heat discarded to a cooling system is 20 to 30%, and a radiation rate from an engine surface is about 5%.

Here, if the flow rate V of the exhaust is a flow rate per unit time (m³/s), the unit of the product PV of the pressure and the flow rate is J/s=W. As a method for converting this energy of the exhaust into work, it is thought to collect the energy as rotational motive power by an exhaust turbine and transmit this rotational motive power to a crankshaft via gears.

However, since a rotational speed difference between the exhaust turbine and the crankshaft is large, a deceleration mechanism for decelerating and transmitting the rotational speed of the exhaust turbine becomes complicated and a part of the motive power is wasted due to a resulting increase in friction or the like. As a result, only a power assist effect of about 3% can be exhibited.

The present invention aims to improve total thermal efficiency by collecting exhaust energy of an engine.

One aspect of the present invention is directed to a hybrid vehicle capable of running using an engine and a motor as drive sources, including an exhaust turbine to be driven and rotated by exhaust of the engine; a generator which generates power by being driven and rotated by the exhaust turbine; and a power supply unit which supplies electric power generated by the generator to a motor.

According to the above aspect, energy of the exhaust of the engine is collected by the exhaust turbine and the collected energy is converted into electric power to drive the motor, wherefore a drive force of the engine can be reduced by as much as the motor is driven and total thermal efficiency of the entire vehicle can be improved.

### BRIEF DESCRIPTION OF DRAWINGS

FIG. 1 is a schematic construction diagram showing the construction of a hybrid vehicle in this embodiment,

FIG. 2 is a sectional view showing a state where a motor is mounted in a bell housing,

FIG. 3 is a sectional view showing the construction of an exhaust turbine generator, and

FIG. 4 is an overall performance chart of an engine showing the principle of fuel economy improvement.

### EMBODIMENTS OF INVENTION

Hereinafter, an embodiment of the present invention is described with reference to the accompanying drawings.

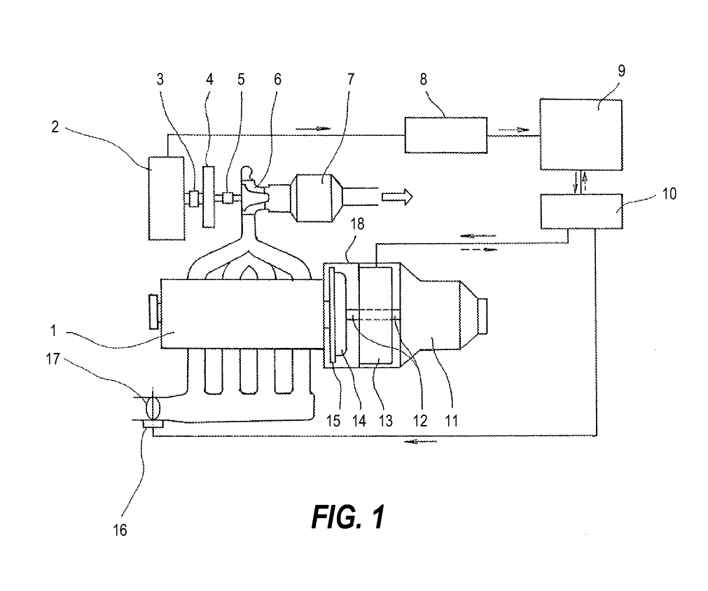

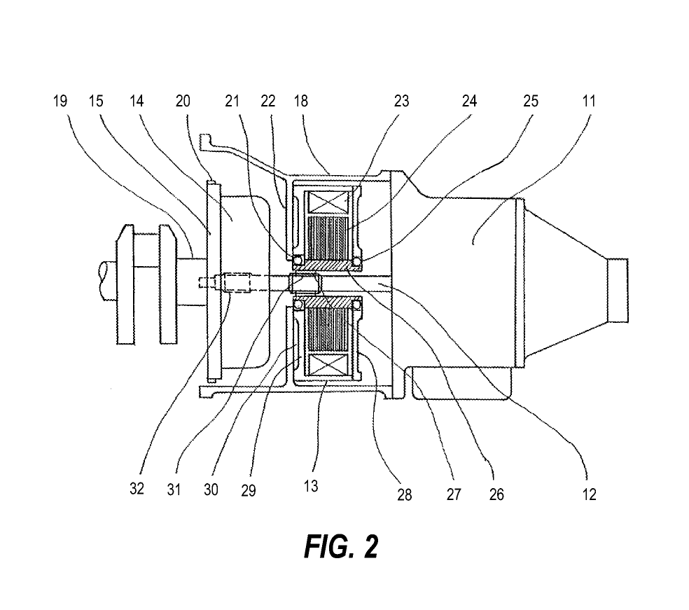

FIG. 1 is a schematic construction diagram showing the construction of a hybrid vehicle in this embodiment. FIG. 2 is a partial sectional view showing the construction from a crankshaft 19 to a transmission 11 in FIG. 1. The hybrid vehicle in this embodiment is such that an engine 1, a motor 13 and a transmission 11 are arranged in this order to form a drive force transmission path and can run on at least either one of drive forces of the engine 1 and the motor 13.

A flywheel 15 and a clutch 14 are provided at the rear end of the crankshaft 19 of the engine 1. In the case of a vehicle including a torque converter, a drive plate and the torque converter are arranged instead of the clutch 14. Further, a main drive shaft 12 is spline-connected to an output side of the clutch 14, and the drive force of the engine 1 is transmitted to the transmission 11 from the main drive shaft 12 via the flywheel 15 and the clutch 14.

The motor 13 includes a case main body 29 fixed to an inner wall of a bell housing 18, a stator coil 23 fixed to the case main body 29 and a rotatable rotor 24 arranged at an inner peripheral side of the stator coil 23. A hub 26 is firmly connected at an inner peripheral end of the rotor 24 by keys, pins, bolts or the like. The hub 26 is rotatably held by bearings 21, 25 interposed between the hub 26 and the case main body 29 at opposite longitudinal ends and spline-connected to the main drive shaft 12, and the drive force of the motor 13 is transmitted from the main drive shaft 12 to the transmission 11.

In this way, the crankshaft 19 of the engine 1 and the motor 13 are arranged on the same axis, and torques from the engine 1 and the motor 13 are transmitted in the same rotational manner to the transmission 11. In a state where a drive force is transmitted from a drive wheel side to the engine 1 such as at the time of coasting, kinetic energy of the vehicle can be collected by causing the motor 13 to operate as a generator.

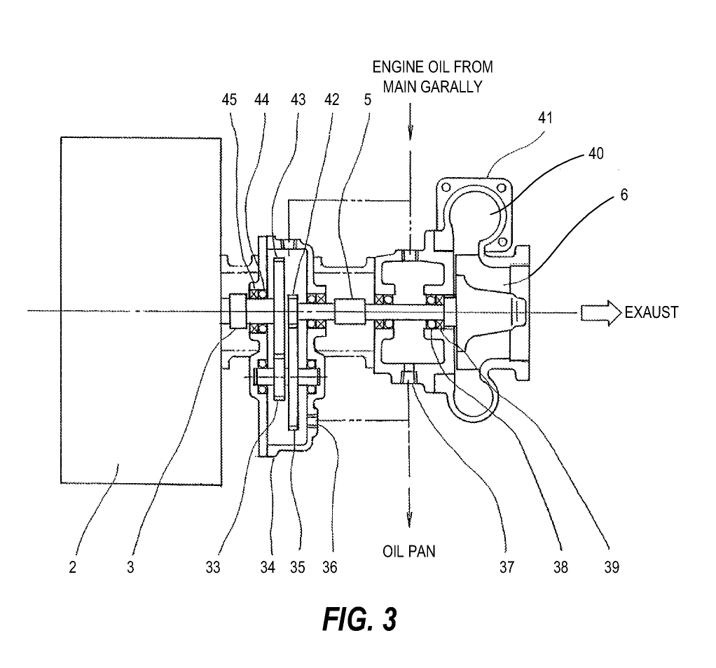

The hybrid vehicle in this embodiment includes an exhaust turbine 6 for collecting exhaust energy of the engine 1, a decelerator 4 for decelerating and outputting the rotational speed of the exhaust turbine 6, and a generator 2 to be driven and rotated by an output shaft of the decelerator 4 in addition to the above construction. FIG. 3 is a partial sectional view showing the construction from the exhaust turbine 6 to the generator 2 in FIG. 1.

Exhaust of the engine 1 swiftly flows into a scroll 40 from an exhaust manifold and drives the exhaust turbine 6, whereby the pressure and temperature thereof decrease, and flows into a catalyst 7 provided downstream of the exhaust turbine 6 at an intermediate position of an exhaust passage.

The exhaust turbine 6 is driven and rotated by the exhaust and the rotation thereof is transmitted to the decelerator 4 via a coupling 5. The coupling 5 has a cylindrical shape having a female spline or serration formed in the inner periphery thereof and is made of a material having low thermal conductivity such as stainless steel to prevent heat transfer. Since the coupling 5 can form a play between rotating shafts of the exhaust turbine 6 and the decelerator 4, application of unnecessary loads to bearings 38, 44 supporting these rotating shafts can be prevented.

The decelerator 4 includes two gear sets (42, 35, 33, 43) each made up of two gears having different tooth numbers and outputs the rotation transmitted from the exhaust turbine 6 while decelerating it in two stages. Note that there may be only one deceleration stage or three or more deceleration stages in the decelerator 4. Since the rotational speed of the exhaust turbine 6 reaches 100,000 rpm at times, the rotation thereof is transmitted to the generator 2 after being decelerated by the decelerator 4. Since having better power generation efficiency when being rotated at a higher speed, the generator 2 is rotated at a higher speed (e.g. at about 20,000 rpm) than it has been conventionally rotated.

Conventionally, the generator 2 is driven by the engine 1 or the like and, in this case, the rotational speed of the generator 2 is relatively low and there has been a limit to high-speed drive. On the contrary, in this embodiment, since the generator 2 is driven and rotated by the exhaust turbine 6 that rotates at a high speed, the rotational speed of the generator 2 can be easily increased.

When the rotational speed of the exhaust turbine 6 reaches a limit value (e.g. 130,000 rpm) or above, there is a possibility of damaging the exhaust turbine 6. Accordingly, the frequency of an alternating current generated by the generator 2 is detected and electric braking is applied by increasing an electrical load by an inverter 8, thereby suppressing excessive rotation of the exhaust turbine 6. Since this obviates the need for bypassing the exhaust by a waste gate valve as in a conventional turbo engine, a system can be simplified.

Lubrication and cooling of the coupling 5 and lubrication of the decelerator 4 are performed by oil discharged from an oil pump of the engine 1. Since decelerator 4 does not reach a high temperature, it needs not be cooled. Accordingly, an oil return port 36 provided at a lower part of a gear case 34 of the decelerator 4 is arranged slightly above the lower end of the gear case 34. This enables the gear 35 to scoop up the oil trapped at the bottom of the gear case 34, whereby the gears 42, 35, 33 and 43 and the bearing 44 in the decelerator 4 can be lubricated.

On the other hand, the hybrid vehicle in this embodiment includes a battery 9, the inverter 8 and a controller 10 in addition to the above construction.

The battery 9 stores electric power generated by the generator 2 and supplies the electric power to the motor 13.

The inverter 8 converts the electric power generated by the generator 2 into a direct current and feeds it to the battery 9. Further, the inverter 8 is capable of electrically adjusting a load of the generator 2 and can suppress an increase in the rotational speed of the exhaust turbine 6 by increasing a power generation load.

The controller 10 supplies the electric power stored in the battery 9 to the motor 13 and sends an opening signal for a throttle valve 17 as a command to an actuator 16 which drives the throttle valve 17 for adjusting an intake air amount of the engine 1.

The electric power generated by the generator 2 driven by the rotation of the exhaust turbine 6 is converted into a direct current having a specified voltage (e.g. 200 V) by the inverter 8 having a load adjusting function and stored in the battery 9. Electrical energy stored in the battery 9 is supplied to the motor 13 via the controller 10 and the motor 13 drives the main drive shaft 12.

Since a torque generated by the engine 1 can be reduced by as much as the torque of the motor 13 by generating the drive force by the motor 13 as described above if a torque necessary to rotate the drive wheels is constant, fuel consumption can be suppressed by that much.

Further, when a large torque is necessary such as at the time of acceleration, the drive force of the engine 1 can be assisted by the motor 13. Thus, an output comparable to a high displacement can be ensured while friction loss is reduced by reducing the displacement of the engine 1 and making the engine 1 smaller.

If an SOC (state of charge) of the battery 9 is equal to or higher than a predetermined amount, the electric power generated by the generator 2 may be directly supplied to the motor 13 without passing through the battery 9. This enables energy collected from the exhaust energy to be more efficiently utilized as a drive force of the vehicle regardless of charge/discharge efficiency.

Further, the controller 10 increases a load of the engine 1 to improve fuel consumption in an operation range where fuel consumption (thermal efficiency) of the engine 1 is poor such as at the time of low-speed/low-load operation.

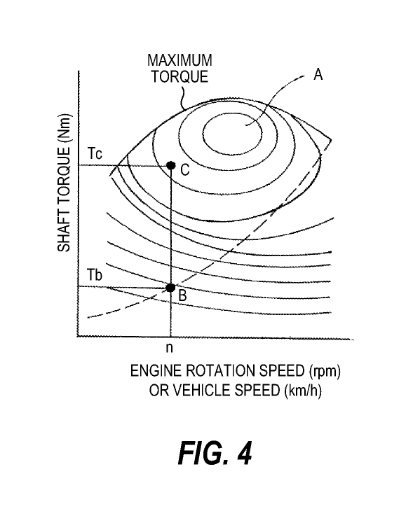

Here, fuel consumption of the engine 1 is described with reference to FIG. 4. FIG. 4 is a map showing a relationship of the rotational speed of the engine or vehicle speed, shaft torque and fuel consumption. As shown in FIG. 4, the fuel consumption is maximized in a state A where the rotational speed is in the vicinity of a rotational speed range where a maximum torque of the engine 1 is generated and a load is high, and deteriorates with distance from the state A.

Dotted line of FIG. 4 indicates a torque necessary to run on a flat road surface. If Tb denotes a torque necessary to run at a rotational speed n, fuel consumption is poor at a point B as an intersection of n and Tb which is largely distant from the state A.

Accordingly, the controller 10 outputs a command to increase the opening of the throttle valve 17 to the actuator 16 and increases a power generation load of the motor 13. This enables the torque necessary to run to be increased to Tc while the rotational speed is kept at n, and the operating state of the engine 1 reaches a state at point C, wherefore fuel consumption is improved.

That is, energy other than that for work necessary to run can be converted into electrical energy and stored in the battery 9 by operating the engine 1 at such a high load as to provide good fuel consumption while keeping the vehicle speed constant. Power generation loss and charge/discharge loss increase by increasing the amount of power generation of the motor 13, but fuel economy can be improved if a gain brought about by fuel consumption improvement is larger than the power generation loss and the charge/discharge loss. Further, since the amount of energy collected from the exhaust turbine 6 increases at this time, the efficiency of the entire system can be further improved.

As described above, the hybrid vehicle in this embodiment uses the kinetic energy of the exhaust, which have been discarded thus far, as a drive force by converting it into electrical energy, and is conceptually totally different from conventional hybrid vehicles in which the drive force of the engine 1 is converted into electrical energy by the generator 2 and work (kinetic energy) transmitted from the drive wheels is converted into electrical energy.

Note that it is possible to add a construction for collecting energy by the motor 13 as in these conventional hybrid vehicles to the hybrid vehicle in this embodiment. In this case, the motor 13 may be used as a motor generator capable of power running/regeneration. That is, at the time of coasting, the motor 13 operates as the generator and electric power flows as indicated by dotted line in FIG. 1 to be stored in the battery 9.

As described above, since the energy of the exhaust of the engine 1 is collected by the exhaust turbine 6 and the collected energy is converted into electric power to drive the motor 13 in this embodiment, the drive force of the engine 1 can be reduced by as much as the motor 13 is driven and fuel economy can be improved by improving the total thermal efficiency of the entire vehicle.

Further, since the electric power generated by the generator 2 can be temporarily stored in the battery 9 and supplied to the motor 13 when a required drive force of the vehicle is increased, energy exhausted from the engine 1 can be efficiently collected and the total thermal efficiency can be improved.

Further, since the power generation load of the generator 2 is increased when the rotational speed of the exhaust turbine 6 exceeds an upper limit rotational speed, excessive rotation of the exhaust turbine 6 can be suppressed without using a waste gate valve or the like and the system can be simplified.

Further, it is determined whether or not the fuel consumption of the engine 1 can be improved by increasing the load of the engine 1, and the load of the engine 1 is increased by increasing the power generation load of the motor 13 when it is determined that improvement is possible. Thus, the engine 1 can be operated at such a high load as to provide good fuel consumption and energy other than that for the work necessary to run can be converted into electrical energy and stored in the battery 9. Therefore, the total thermal efficiency of the vehicle can be improved.

Further, since the rotational speed of the exhaust turbine 6 is decelerated and transmitted to the generator 2 by the decelerator 4, the generator 2 can be rotated at such a rotational speed as to provide good power generation efficiency.

Further, since the coupling 5 is interposed between the exhaust turbine 6 and the decelerator 4, the transfer of heat of the exhaust turbine 6 to the decelerator 4 can be prevented and a very small misalignment of rotating shafts can be absorbed. Thus, application of excessive loads to the bearings 38, 44 can be prevented.

The embodiment of the present invention has been described above. The above embodiment is merely illustration of an application example of the present invention and not of the nature to limit the technical scope of the present invention to the specific construction of the above embodiment. Various changes can be made without departing from the gist of the present invention.

The present application claims a priority based on Japanese Patent Application No. 2010-277911 filed with the Japanese Patent Office on Dec. 14, 2010, all the contents of which are hereby incorporated by reference.

1. A hybrid vehicle capable of running using an engine and a motor as drive sources, comprising:
an exhaust turbine to be driven and rotated by exhaust of the engine;
a generator which generates power by being driven and rotated by the exhaust turbine; and
a power supply unit which supplies electric power generated by the generator to the motor.

2. The hybrid vehicle according to claim 1, further comprising a battery for storing the electric power generated by the generator, wherein:
the power supply unit supplies the electric power stored in the battery to the motor.

3. The hybrid vehicle according to claim 1, further comprising:
a power generation load increasing unit which increases a power generation load of the generator when the rotational speed of the exhaust turbine exceeds an upper limit rotational speed.

4. The hybrid vehicle according to claim 1, further comprising:
a fuel consumption determining unit which determines whether or not fuel consumption of the engine can be improved by increasing a load of the engine; and
an engine load increasing unit which increases the load of the engine by increasing the power generation load of the motor when it is determined that the fuel consumption of the engine can be improved.

5. The hybrid vehicle according to claim 1, further comprising:
a decelerator which decelerates and transmits the rotational speed of the exhaust turbine to the generator.

6. The hybrid vehicle according to claim 5, further comprising:
a coupling interposed between the exhaust turbine and the decelerator.

7. The hybrid vehicle according to claim 1, wherein:
the motor is a motor generator capable of power running and regeneration.
